(19) United States
(12) Patent Application Publication
(10) Pub. No.: US 2026/0313340 A1
(43) Pub. Date: Oct. 8, 2026

(54) AUTOMATIC SLOT IDENTIFIER DETECTION AND MANAGEMENT FOR RACK SYSTEMS

(71) Applicant: Quanta Computer Inc., Taoyuan City (TW)

(72) Inventors: Ying-Huan CHEN, Taoyuan City (TW); Chun-Chia SU, Taoyuan City (TW); Wei-Tsung TANG, Taoyuan City (TW); Yangtzu LEE, Taoyuan City (TW)

(21) Appl. No.: 19/222,097

(22) Filed: May 29, 2025

Related U.S. Application Data
(60) Provisional application No. 63/783,048, filed on Apr. 3, 2025.

(51) Int. Cl. H04W 4/80; H04W 4/02

(52) U.S. Cl. CPC H04W 4/80; H04W 4/023

(57) ABSTRACT

A computing system for identifying a slot in a server rack includes a compute tray and a server rack that has multiple insertion slots. Each insertion slot has a passive near field communication (NFC) tag mounted therein. The NFC tag is encoded with data including a slot identifier. The compute tray has an NFC reader module. The compute tray is movable between a non-inserted position and an inserted position relative to the insertion slot. When the compute tray is in the inserted position, the NFC reader module positionally aligns with the NFC tag, and the NFC reader module wirelessly communicates with the NFC tag to retrieve the data encoded on the NFC tag. A processor on the compute tray is coupled to communicate with the NFC reader module. The processor is configured to receive the data from the NFC reader module and decode the data to extract the slot identifier.

### FIELD OF THE INVENTION

The present invention relates generally to a system and method for detecting and managing the slot identifiers of insertion slots for a server rack. More specifically, the present invention relates to a system and method that detects the slot identifier for an insertion slot into which a compute tray is inserted, and then updates an inventory of compute trays and their operational positions within the server rack.

### BACKGROUND OF THE INVENTION

In conventional high-density server architectures, backplanes are commonly used to manage slot positions and identification signals. However, such designs increase mechanical complexity, raise manufacturing costs, and complicate system maintenance. Once deployed, modifying or scaling a backplane-based system often involves substantial rework or downtime. A need exists for automatic slot ID detection and management in rack systems, without relying on a dedicated backplane.

### SUMMARY OF THE INVENTION

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to certain aspects of the present disclosure, a computing system for identifying a slot in a server rack includes a server rack and a compute tray. The server rack has multiple insertion slots. Each insertion slot has a passive near field communication (NFC) tag mounted in the insertion slot. The NFC tag is encoded with data including a slot identifier. The compute tray has an NFC reader module. The compute tray is movable between a non-inserted position and an inserted position relative to the insertion slot. When the compute tray is in the inserted position, the NFC reader module positionally aligns with the NFC tag. When the compute tray is in the inserted position, the NFC reader module wirelessly communicates with the NFC tag to retrieve the data encoded on the NFC tag. A processor on the compute tray is coupled to communicate with the NFC reader module. The processor is configured to receive the data from the NFC reader module and decode the data to extract the slot identifier.

According to certain aspects of the present disclosure, once the compute tray is inserted into the insertion slot and powered on, the NFC reader module wirelessly reads the data encoded on the NFC tag and subsequently enters a power-saving mode. The NFC reader module performs another read of the NFC tag only upon a defined trigger event.

According to certain aspects of the present disclosure, the defined trigger event includes removal and reinsertion of the compute tray, a command issued by a rack management controller, a user-initiated diagnostic request, or any combination thereof.

According to certain aspects of the present disclosure, the NFC reader module includes at least an NFC reader and an antenna.

According to certain aspects of the present disclosure, the computing system further includes a rack management controller and a network management controller. The rack management controller is coupled to communicate with the processor. The network management controller is coupled to communicate with the processor. The processor is configured to communicate the slot identifier to the rack management controller and the network management controller.

According to certain aspects of the present disclosure, the rack management controller and the network management controller are housed in the server rack.

According to certain aspects of the present disclosure, the processor communicates with the rack management controller and the network management controller via separate communication interface buses.

According to certain aspects of the present disclosure, the rack management controller dynamically updates inventory and operational mapping to include the compute tray being within the server rack. The dynamic update is based at least in part on receipt of the communication of the slot identifier from the processor.

According to certain aspects of the present disclosure, the slot identifier for each of the multiple insertion slots is unique within the server rack.

According to certain aspects of the present disclosure, a computing system for identifying a slot in a server rack includes a server rack and a compute tray. The server rack has an insertion slot. The insertion slot has a passive near field communication (NFC) tag mounted in the insertion slot. The NFC tag is encoded with data including a slot identifier that is unique within the server rack. The compute tray has an NFC reader module. The compute tray is movable between a non-inserted position and an inserted position relative to the insertion slot. When the compute tray is in the inserted position, the NFC reader module positionally aligns with the NFC tag. The NFC reader module wirelessly reads the data encoded on the NFC tag once after insertion and power-up. The NFC reader module subsequently enters a power-saving mode. The NFC reader module performs additional reads of the NFC tag only when specifically required. A processor on the compute tray is coupled to communicate with the NFC reader module. The processor is configured to receive the data from the NFC reader module and decode the data to extract the slot identifier.

According to certain aspects of the present disclosure, the NFC reader module includes at least an NFC reader and an antenna.

According to certain aspects of the present disclosure, the computing system further includes a rack management controller and a network management controller. The rack management controller is housed in the server rack and coupled to communicate with the processor. The network management controller is housed in the server rack and coupled to communicate with the processor. The processor is configured to communicate the slot identifier to the rack management controller and the network management controller.

According to certain aspects of the present disclosure, the processor communicates with the rack management controller and the network management controller via separate communication interface buses.

According to certain aspects of the present disclosure, the rack management controller dynamically updates inventory and operational mapping to include the compute tray being within the server rack. The dynamic update is based at least in part on receipt of the communication of the slot identifier from the processor.

According to certain aspects of the present disclosure, a method for automatic slot identifier detection and management for a compute tray in a server rack includes receiving a compute tray having a near field communication (NFC) reader module into an insertion slot of the server rack. The insertion slot has a passive NFC tag mounted in the insertion slot. The NFC tag is encoded with data including a slot identifier. The method further includes positionally aligning the NFC reader module with the NFC tag upon receiving the compute tray into the insertion slot. The method further includes retrieving the data encoded on the NFC tag. The data is retrieved via the NFC reader module wirelessly communicating with the NFC tag. The method further includes a processor on the compute tray receiving the data from the NFC reader module. The method further includes the processor decoding the data to extract the slot identifier.

According to certain aspects of the present disclosure, before retrieving the data encoded on the NFC tag, the method further includes powering on the compute tray. After the processor receiving the data from the NFC reader module, the method further includes the NFC reader module entering a power-saving mode. The method further includes the NFC reader module in the power-saving mode performing another read of the NFC tag only upon a defined trigger event.

According to certain aspects of the present disclosure, the method further includes the processor communicating the slot identifier to a rack management controller housed in the server rack. The method further includes the processor communicating the slot identifier to a network management controller housed in the server rack.

According to certain aspects of the present disclosure, the processor communicates with the rack management controller and the network management controller via separate communication interface buses.

According to certain aspects of the present disclosure, the method further includes the rack management controller dynamically updating inventory and operational mapping to include the compute tray being within the server rack. The dynamic updating is based at least in part on receipt of the communication of the slot identifier from the processor.

According to certain aspects of the present disclosure, the slot identifier for each insertion slot is unique within the server rack.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIG. 1 is a schematic diagram of an exemplary insertion slot identifier detection and management system for a server rack, according to certain aspects of the present disclosure.

FIG. 2 is a schematic diagram of an exemplary compute tray in an uninserted position, according to certain aspects of the present disclosure.

FIG. 3 is a schematic diagram of an exemplary server rack empty of compute trays, according to certain aspects of the present disclosure.

FIG. 4 shows steps of an exemplary method for automatically detecting and managing the slot identifiers in a server rack, according to certain aspects of the present disclosure.

### DETAILED DESCRIPTION

The current invention is a system and method for automatically detecting a slot identifier associated with an insertion slot of a server rack when a compute tray is inserted into the insertion slot. An NFC reader module on the compute tray communicates with an NFC tag in the insertion slot to retrieve the slot identifier from the NFC tag. A processor on the compute tray communicates the slot identifier to a rack management controller. The rack management controller dynamically updates an inventory and operational mapping of compute trays in the server rack based on the received slot identifier.

Various embodiments are described with reference to the attached figures, where like reference numerals are used throughout the figures to designate similar or equivalent elements. Each reference numeral identifies the figure in which the reference numeral first appears based on the first digit (for three-digit reference numerals) or the first two digits (for four-digit reference numerals) corresponding to the figure numeral of the figure. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

To solve the problems associated with backplanes used in conventional high-density server architectures, a backplane-free slot identification method utilizing Near Field Communication (NFC) technology is disclosed. Each compute tray is equipped with an NFC reader module. A corresponding insertion slot region on the canister side wall of the server rack contains a passive NFC tag encoding a unique slot identifier. When the compute tray is inserted, the NFC reader automatically scans the nearby NFC tag and obtains the predefined slot identifier. This system and method eliminates the need for electrical slot identifier connections and complex wiring through the backplane. Compared to traditional solutions, this NFC-based system and method offers improved modularity, simpler hardware integration, and greater flexibility for system upgrades or tray replacements. This NFC-based system and method requires no physical backplane signals or reflective detection mechanisms, and allows the compute tray to seamlessly update its slot identifier whenever it is relocated.

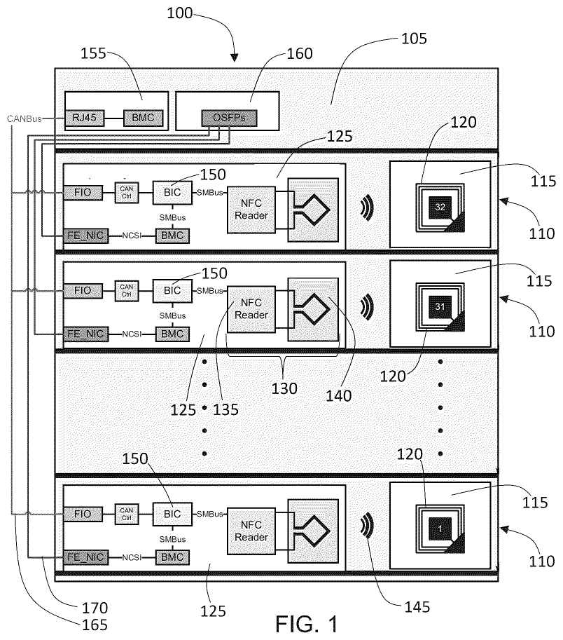

Referring to FIG. 1, an embodiment of a computing system 100 is schematically illustrated. A server rack 105 is shown in a cross-sectional view that illustrates an inside of the server rack 105. The server rack 105 has a plurality of insertion slots 110. Each insertion slot 110 includes a passive near field communication (NFC) tag 115 mounted inside the insertion slot 110. For example, the passive NFC tag 115 is mounted on a side wall of the insertion slot 110.

The passive NFC tag 115 is encoded with data including a slot identifier 120. In reality, the slot identifier 120 is electronically encoded on each passive NFC tag 115 and is not visible. However, as a representative exemplary visual aid, each of the passive NFC tags 115 is labeled in FIG. 1 with a visible decimal representation of the slot identifier 120. In this example, there are 32 insertion slots 110. In other examples, there can be more or less than 32 insertion slots 110. The slot identifier 120 for each of the plurality of insertion slots 110 is unique within the server rack 105.

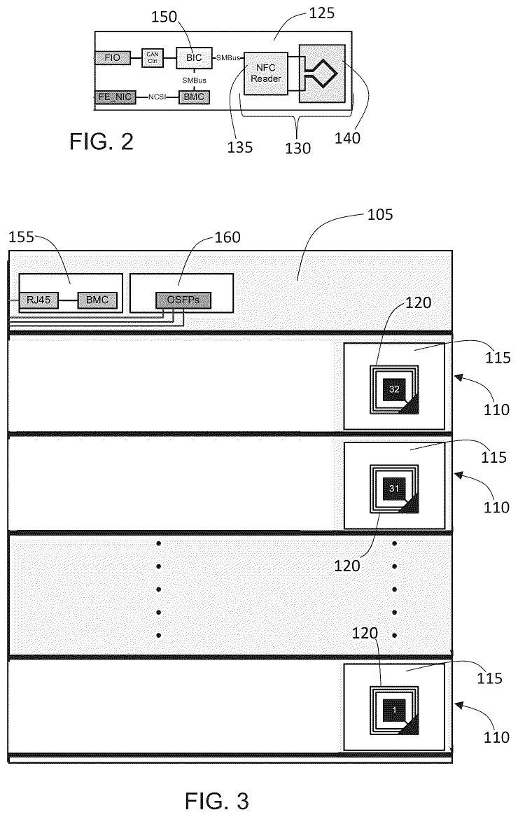

A compute tray 125 includes an NFC reader module 130. In an embodiment, the NFC reader module 130 includes at least an NFC reader 135 and an antenna 140. The compute trays 125 shown in FIG. 1 are each in an inserted position inside an insertion slot 110. Referring briefly to FIG. 2, a compute tray 125 is shown in a non-inserted position outside of the server rack 105. Referring briefly to FIG. 3, the server rack 105 is shown with all of the compute trays 125 removed. Referring to FIGS. 1 and 2, each compute tray 125 is movable between a non-inserted position (see FIG. 2) and an inserted position (see FIG. 1) relative to an insertion slot 110.

Referring to FIG. 1, when the compute tray 125 is in the inserted position within the insertion slot 110, the NFC reader module 130 positionally aligns with the passive NFC tag 115. When the compute tray 125 is in the inserted position within the insertion slot 110, the NFC reader module 130 wirelessly communicates with the passive NFC tag 115 within the insertion slot 110. The NFC reader module 130 retrieves the data encoded on the passive NFC tag 115. For example, the NFC reader module 130 emits a low-power electromagnetic field to activate and read the passive NFC tag 115. The passive NFC tag 115 responds by transmitting its stored data, which includes a slot identifier 120 for the insertion slot 110. Such wireless communication is schematically shown in FIG. 1, by the advancing wave fronts 145.

A processor 150 on the compute tray 125 is communicatively coupled with the NFC reader module 130. The processor 150 is configured to receive the data from the NFC reader module 130 and decode the data to extract the slot identifier 120. In an embodiment, once the compute tray 125 is inserted into the insertion slot 110 and powered on, the NFC reader module 130 wirelessly reads the data encoded on the passive NFC tag 115, transmits the data to the processor 150, and then enters a power-saving mode.

Upon entering the power-saving mode, the NFC reader module 130 will only perform another read of the data on the passive NFC tag 115 if specifically required, or if triggered by a defined trigger event. For example, the defined trigger event could include: (a) removal of the compute tray 125 from the insertion slot 110 and re-insertion of the compute tray 125 into the insertion slot 110, (b) a command issued by a rack management controller 155 (see below); (c) a user-initiated diagnostic request; or any combination of (a), (b), and (c).

In an embodiment, the computing system 100 further includes a rack management controller 155 communicatively coupled with the processor 150. A network management controller 160 is also communicatively coupled with the processor 150. In an embodiment, the processor 150 on the compute tray 125 automatically reports its detected slot identifier to the rack management controller 155 or other management software through a communication interface such as controller area network (CAN) bus or SMBus®. In an embodiment, the processor 150 is configured to communicate the slot identifier 120 to the rack management controller 155 and to the network management controller 160.

In an embodiment, the rack management controller 155 and the network management controller 160 are both housed in the server rack 105. In other embodiments, one or both of the rack management controller 155 and the network management controller 160 is housed outside of the server rack 105. The processor 150 communicates with the rack management controller 155 via a first communication interface bus 165. The processor 150 communicates with the network management controller 160 via a second communication interface bus 170.

The rack management controller 155 dynamically updates the inventory of compute trays 125 that are inserted into insertion slots 110 of the server rack 105. The rack management controller also dynamically updates the operational mapping of the compute trays 125 by associating each inserted compute tray 125 with a slot identifier 120 for the server rack 105. To do these dynamic updates, whenever a compute tray 125 is inserted into the server rack 105, the rack management controller 155 receives the slot identifier 120 for the compute tray 125 just inserted. Upon receiving the slot identifier 120, the rack management controller 155 updates the inventory and operational mapping for the server rack 105 to include the compute tray 125 just inserted.

Removal of a compute tray 125 from the server rack 105, will cause the processor 150 on the compute tray to stop communicating the slot identifier 120 to the rack management controller 155. This loss of communication of the slot identifier 120 will cause the rack management controller 155 to dynamically update the inventory and operational mapping for the server rack 105 to exclude the just removed compute tray 125.

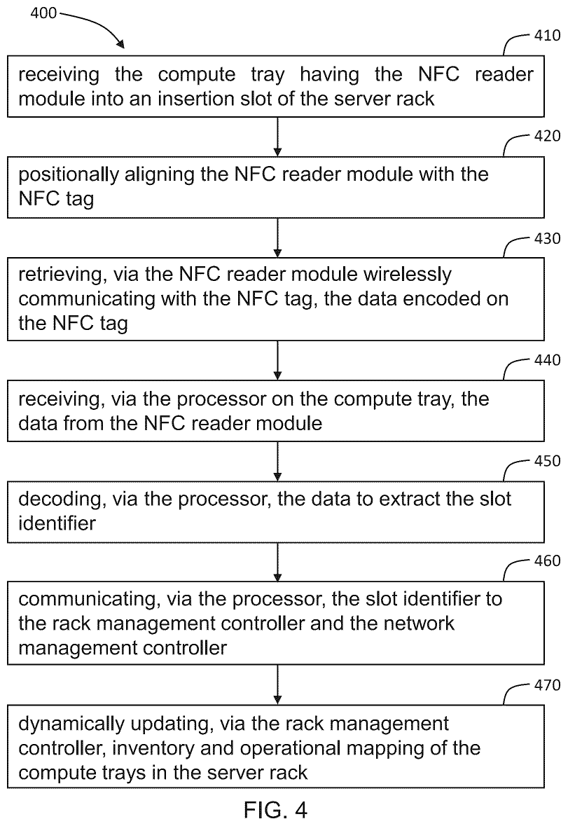

A computing system 100 that automatically detects and manages the slot identifier 120 for the insertion slot 110, into which a compute tray 125 is inserted is described herein. Referring to FIGS. 1 and 4, a method 400 for automatically detecting and managing the slot identifiers 120 begins at step 410. At step 410, the compute tray 125 having the NFC reader module 130 is received into an insertion slot 110 of the server rack 105. The insertion slot 110 has the passive NFC tag 115 mounted in the insertion slot 110. The passive NFC tag 115 is encoded with data that includes the slot identifier 120.

At step 420, the NFC reader module 130 is positionally aligned to wirelessly communicate with the passive NFC tag 115. The positional alignment occurs as a result of receiving the compute tray 125 into the insertion slot 110. At step 430, the NFC reader module 130 wirelessly communicates with the passive NFC tag 115 to retrieve the data encoded on the passive NFC tag 115. At step 440, the processor 150 on the compute tray 125 receives the data from the NFC reader module. At step 450, the processor 150 decodes the data to extract the slot identifier 120. In an embodiment, once the compute tray 125 is inserted into the insertion slot 110 and powered on, the NFC reader module 130 wirelessly reads the data encoded on the passive NFC tag 115, transmits the data to the processor 150, and then enters a power-saving mode.

Upon entering the power-saving mode, the NFC reader module 130 will only perform another read of the data on the passive NFC tag 115 if specifically required, or if triggered by a defined trigger event. For example, the defined trigger event could include: (a) removal of the compute tray 125 from the insertion slot 110 and re-insertion of the compute tray 125 into the insertion slot 110, (b) a command issued by a rack management controller 155 (see below); (c) a user-initiated diagnostic request; or any combination of (a), (b), and (c).

The method 400 continues at step 460, where the processor 150 communicates the slot identifier 120 to the rack management controller 155 and to the network management controller 160. As noted above, the processor 150 communicates with the rack management controller 155 and the network management controller 160 via separate communication interface buses 165 and 170, respectively. At step 470, the rack management controller 155 dynamically updates the inventory and operational mapping of the compute trays 125 to include the compute tray 125 just inserted into the insertion slot 110 of the server rack 105. The dynamic update is based at least in part on receipt of the communication of the slot identifier 120 from the processor 150. If the compute tray 125 is removed from the server rack 105, the rack management controller 155 dynamically updates inventory and operational mapping of the compute trays 125 to exclude the compute tray 125 just removed from the insertion slot 110 of the server rack 105.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above described embodiments. Rather, the scope of the disclosure should be defined in accordance with the following claims and their equivalents.

What is claimed is:

1. A computing system for identifying a slot in a server rack, the computing system comprising:
a server rack having a plurality of insertion slots, each insertion slot of the plurality of insertion slots having a passive near field communication (NFC) tag mounted in the insertion slot, the NFC tag encoded with data including a slot identifier;
a compute tray having an NFC reader module, the compute tray being movable between a non-inserted position and an inserted position relative to the respective insertion slot such that when the compute tray is in the inserted position;
the NFC reader module positionally aligns with the NFC tag; and
the NFC reader module wirelessly communicates with the NFC tag to retrieve the data encoded on the NFC tag; and
a processor on the compute tray and communicatively coupled with the NFC reader module, the processor configured to receive the data from the NFC reader module and decode the data to extract the slot identifier.

2. The computing system of claim 1, wherein once the compute tray is inserted into the insertion slot and powered on, the NFC reader module wirelessly reads the data encoded on the NFC tag and subsequently enters a power-saving mode, whereupon the NFC reader module performs another read of the NFC tag only upon a defined trigger event.

3. The computing system of claim 2, wherein the defined trigger event comprises removal and reinsertion of the compute tray, a command issued by a rack management controller, a user-initiated diagnostic request, or any combination thereof.

4. The computing system of claim 1, wherein the NFC reader module includes at least an NFC reader and an antenna.

5. The computing system of claim 1, further comprising:
a rack management controller communicatively coupled with the processor; and
a network management controller communicatively coupled with the processor;
wherein the processor is configured to communicate the slot identifier to the rack management controller and the network management controller.

6. The computing system of claim 5, wherein the rack management controller and the network management controller are housed in the server rack.

7. The computing system of claim 5, wherein the processor communicates with the rack management controller and the network management controller via separate communication interface buses.

8. The computing system of claim 5, wherein the rack management controller is configured to dynamically update inventory and operational mapping to include the compute tray being within the server rack based at least in part on receipt of the communication of the slot identifier from the processor.

9. The computing system of claim 1, wherein the slot identifier for each of the plurality of insertion slots is unique within the server rack.

10. A computing system for identifying a slot in a server rack, the computing system comprising:
a server rack having an insertion slot having a passive near field communication (NFC) tag mounted in the insertion slot, the NFC tag encoded with data including a slot identifier that is unique within the server rack;
a compute tray having an NFC reader module, the compute tray being movable between a non-inserted position and an inserted position relative to the respective insertion slot such that when the compute tray is in the inserted position;
the NFC reader module positionally aligns with the NFC tag; and
the NFC reader module wirelessly reads the data encoded on the NFC tag once after insertion and power-up, and subsequently enters a power-saving mode, whereupon the NFC reader module performs additional reads of the NFC tag only when specifically required; and
a processor on the compute tray and communicatively coupled with the NFC reader module, the processor configured to receive the data from the NFC reader module and decode the data to extract the slot identifier.

11. The computing system of claim 10, wherein the NFC reader module comprises at least an NFC reader and an antenna.

12. The computing system of claim 10, further comprising:
a rack management controller housed in the server rack and communicatively coupled with the processor; and
a network management controller housed in the server rack and communicatively coupled with the processor;
wherein the processor is configured to communicate the slot identifier to the rack management controller and the network management controller.

13. The computing system of claim 12, wherein the processor communicates with the rack management controller and the network management controller via separate communication interface buses.

14. The computing system of claim 12, wherein the rack management controller is configured to dynamically update inventory and operational mapping to include the compute tray being within the server rack based at least in part on receipt of the communication of the slot identifier from the processor.

15. A method for automatic slot identifier detection and management for a compute tray in a server rack, the method comprising:
receiving a compute tray having a near field communication (NFC) reader module into an insertion slot of the server rack, the insertion slot having a passive NFC tag mounted in the insertion slot, the NFC tag being encoded with data including a slot identifier;
upon receiving the compute tray into the insertion slot, positionally aligning the NFC reader module with the NFC tag;
retrieving, via the NFC reader module wirelessly communicating with the NFC tag, the data encoded on the NFC tag;
receiving, via a processor on the compute tray, the data from the NFC reader module; and
decoding, via the processor, the data to extract the slot identifier.

16. The method of claim 15, wherein before retrieving the data encoded on the NFC tag, powering on the compute tray, and after the processor receiving the data from the NFC reader module, the NFC reader module entering a power-saving mode, the NFC reader module in the power-saving mode performing another read of the NFC tag only upon a defined trigger event.

17. The method of claim 15, further comprising communicating, via the processor, the slot identifier to a rack management controller housed in the server rack and to a network management controller housed in the server rack.

18. The method of claim 17, wherein the processor communicates with the rack management controller and the network management controller via separate communication interface buses.

19. The method of claim 17, further comprising dynamically updating, via the rack management controller, inventory and operational mapping to include the compute tray being within the server rack based at least in part on receipt of the communication of the slot identifier from the processor.

20. The method of claim 15, wherein the slot identifier for each insertion slot is unique within the server rack.
